(19) United States
(12) Patent Application Publication
(10) Pub. No.: US 2006/0230438 A1
(43) Pub. Date: Oct. 12, 2006

(54) Single sign-on to remote server sessions using the credentials of the local client

(75) Inventors: Dan Shappir, Tel Aviv (IL); Eran Heyman, Closter, NJ (US); Dror Shilo, Jerusalem (IL)

Correspondence Address: DR. MARK FRIEDMAN LTD.;c/o Bill Polkinghorn, 9003 Florin Way, Upper Marlboro, MD, 20772, US

(73) Assignee: ERICOM SOFTWARE LTD.

(21) Appl. No.: 11/398,553

(22) Filed: Apr. 6, 2006

Related U.S. Application Data
(60) Provisional application No. 60/668,589, filed on Apr. 6, 2005.

(51) Int. Cl. G06F 17/30

(52) U.S. Cl. 726/8

(57) ABSTRACT

A method for single sign-on in a client-server system including a server and a client and a remote presentation protocol based on ITU T.120, communicates between the client node and the server. The client obtains a ticket for a user operating the client. The ticket identifies the security context of the user on the client. Upon connecting the client to the server, the ticket is transferred from the client to the server. The server authenticates the ticket with a security authority and when authenticated the server receives from the security authority a security context for the ticket. When the client so requests, applications are launched using that security context. Preferably, the server is a Microsoft Terminal Server and the remote presentation protocol is Microsoft Remote Desktop Protocol (RDP). The ticket transfer preferably uses a channel within the remote presentation protocol, such as an RDP virtual channel.

### CROSS REFERENCE TO RELATED APPLICATIONS

This application claims the benefit from U.S. provisional application 60/668,589 filed 6 Apr. 2005 by the present inventors.

### FIELD AND BACKGROUND OF THE INVENTION

The present invention relates to client-server computer networks using a remote presentation protocol. More specifically, the present invention relates to a method for performing single sign-on to a Microsoft Terminal Server so that a user need not reenter identification or authentication information, such as username, password and domain. Instead a ticket representing credential information of the user on the client node is used to automatically sign-on to the Terminal Server and launch applications on the Terminal Server in the same security context as that of the user on the client node.

Microsoft Terminal Server is a multi-user operating system designed to allow remote client devices to access and use applications in a model in which applications are installed on one or more central servers and accessed from client nodes that provide only the display and user input functionality. This architecture is commonly referred to as Server Based Computing (SBC). Recent years have seen a resurgence of Server Based Computing as a preferred model for application deployment, access and use. The benefits of Server Based Computing include simplified application deployment and updates, the ability to use cheaper client devices, and improved security. The three main components that make up a Server Based Computing environment are:

1. One or more servers running a multi-user operating system.

2. A remote presentation protocol

3. Client software and device

Microsoft Windows has been traditionally a client-oriented platform, with applications running directly on the client-node, and having only a limited use of central resources, such as network printers and file servers. The introduction of Microsoft Terminal Server as an effective implementation of a Windows-compatible multi-user operating system, coupled with introduction of remote presentation protocols, such as Microsoft Remote Desktop Protocol (RDP), have made Server Based Computing a viable solution for Microsoft environments. RDP is based on, and an extension of, the International Telecommunications Union ITU T.120 family of protocols. RDP is a multiple-channel capable protocol that allows for separate virtual channels for carrying device communication and presentation data from the server, as well as encrypted client mouse and keyboard data. Further information regarding ITU T.120 protocols is published and distributed by ITU including “Data protocols for multimedia conferencinig”, Recommendation T.120 (07/96) included herein by reference for all purposes as if entirely set forth herein.

Because applications are running on servers, the clients must connect to the servers before these applications can be used. Also, because individual users are generally provided unique access rights and privileges, an authentication process is required when connecting to the servers. The authentication process is used to identify and authenticate the users. Identification is performed using a username, sometimes also with additional information such as domain or workgroup, and authentication is performed using a password. Other equivalent credentials may be used instead. Access to the server resources is allowed only after the user has been properly identified and authenticated.

In many cases the user must also sign on to the client before being able to use the client's functionality, including the ability to connect to servers. In such cases, the user is identified and authenticated twice: first by the client and then by the Terminal Server. If this identification and authentication is performed manually, by typing in the credentials, it can become an inconvenience to the user. If the user connects to multiple sessions on one or more Terminal Servers, identification and authentication will need to be performed independently for each session, inconveniencing the user to an even greater degree. For example, if a client is used primarily for server access, connection to the server will be performed during the client's login process. The user will then be required to enter the same authentication information twice in a row, once for the client, and then again immediately for the server.

This inconvenience can be alleviated to some extent by storing the user's credentials for a particular server or servers in a fixed store on the client. In this way, the authentication information can be read automatically from fixed storage attached to the client, and transmitted to the server without requiring the user to manually reenter the authentication information. This scheme, sometimes known as Automatic Login, is especially useful when the client and server require different authentication information.

There are potentially significant limitations to storing authentication information on the client in this way:

1. Though authentication information in fixed storage is usually encrypted, a hacker may still be able to extract the authentication information from the store, thus compromising security of the server. As a result, some organizations prohibit storing authentication information on client devices, especially if the devices are mobile.

2. Authentication information is usually changed periodically for security reasons. This means that information in storage must also be changed accordingly otherwise the server authentication will fail. Changing the information in storage can be cumbersome because authentication information for each server connection is usually stored separately.

3. For security reasons, the encryption of the server's authentication information is often particular to a specific client. This means that the contents of the stole cannot be copied over to another client device. As a result the authentication content in storage must be created individually on each client device the user may use.

A solution that does not suffer from these limitations is to use the client's own login credentials to login to the server. Many operating systems and network security infrastructures make it possible for an application to obtain a ticket, sometimes referred to as a token or key, which represents its security context. In most cases this security context is the one provided for the user at login based on the user's identity. This ticket can be transferred to another system in the same network, and be used there to instantiate applications or sessions with the same security context. In some cases the original ticket is not transferable itself, and must be used instead to obtain a transferable ticket from the network's authentication authority. Current implementations of Microsoft Terminal Servers and the Microsoft Remote Desktop Protocol (RDP) do not provide the functionality of authenticating a user using a ticket that represents the user's security context on the client device. As a result, single sign-on using this scheme of transferable tickets is not supported by Microsoft Terminal Servers and RDP.

Reference is now made to FIG. 2 (prior art), illustrating a conventional Server Based Computing (SBC) system which requires client (210) to connect to a terminal server (220) in order to access applications and services. For SBC solutions based on Microsoft Terminal Services and the Microsoft RDP protocol, the user is required to provide credential information, e.g. username, password and domain, as a part of the connection process (230). Current versions of Microsoft Terminal Services and the Microsoft RDP protocol used to connect to these services do not support single sign-on using tickets as described above. As a result, the user must either manually provide credentials for each connection or use Automatic Login. As previously described, Automatic Login has some significant limitations when compared to single sign-on mechanisms.

There is thus a need for, and it would be highly advantageous to have a method of single sign-on implemented in Microsoft Terminal Servers using Microsoft Remote Desktop Protocol (RDP), a method other than than automatic login and devoid of the above mentioned limitations.

Modern operating systems and network security environments grant individual users unique access rights and privileges based on their identity and groups to which they belong. In order to assign the appropriate rights and privileges to each user, a login process is required during which the user is identified and then authenticated. The purpose of the identification step is to determine who the user is and which resources are available to him. The purpose of the authentication step is to verify that the user is indeed who he claims he is, and authentication is performed by requesting the user to enter information that is only known to him and can be verified as correct by the system. The two steps of identification and authentication are usually performed in tandem, using credential information provided by the user, such as a username and password.

Some enterprises contain numerous interconnected services, systems and applications, each one of which may requires identification and authentication. Unless steps are taken to prevent such a scenario, users in such environments may be required to reenter credential information every time they require access to these services, systems and applications. This can be detrimental to the usability of the entire environment and frustrating to the end user. It can also result in security vulnerabilities as users attempt to circumvent the rigidity of the environment, for example by creating plain-text macros to log into various services.

The solution to this problem is to use single sign-on (SSO). Single sign-on is an authentication process in a client/server relationship where the user, or client, can enter one name and password, or equivalent credential information, and have access to more than one application or access to a number of resources within an enterprise. Single sign-on removes the requirement for the user to enter further authentications when switching from one application or service to another.

Integrated Windows Authentication (IWA), formerly known as NTLM (NT LAN Manager), is a computer networking cryptography protocol that operates in a variety of Microsoft Windows network protocols for authentication purposes. Like certain other protocols, IWA sits on top of HTTP. Web-browsing software uses IWA as a single sign-on mechanism, so browsing users can transparently log-on to web services using their Microsoft Windows credentials.

Kerberos is a computer network authentication protocol which allows individuals communicating over an insecure network to prove their identity to one another in a secure manner. Kerberos prevents eavesdropping or replay attacks, and ensures the integrity of the data. Kerberos was designed for the client-server model, and provides mutual authentication, both the user and the service verify each othier's identity. Kerberos builds on symmetric key cryptography and requires a trusted third party. Kerberos typically uses an authentication server, a Ticket Granting Server, service providing server. In Kerberos protocol, the client authenticates itself to the authentication server, then demonstrates to the ticket granting server that it is authorized to receive a ticket for a service and receives the ticket. Then the client demonstrates to the service providing server that it has been approved to receive the service.

ITU T.120: Multipoint Data Conferencing and Real Time Communication Protocols include

The terms “ITU T.120 standard” as used herein includes any of a suite of communication and application protocols, T.121, T.122, T.123, T.124, T.125, T.126, T.127, which are designed for multipoint Data Conferencing and real time communication including multilayer protocols which enhance multimedia, multipoint control unit (MCU) and codec control capabilities.

A GINA graphical identification and authentication dynamic link (DLL) library provides secure login services on Microsoft Windows operating systems. The GINA is a replaceable DLL component that is loaded by the Winlogon executable module, a component of the Windows operating system that provides interactive logon support. The GINA implements the authentication policy of the interactive logon model and is expected to perform all identification and authentication user interactions.

The terms “client”, “client node” and “client device” are used her-ein interchangeably. The tends “server”, “terminal server” and “server node” are used herein interchangeably. The terms “ticket” and “token” are used herein interchangeably.

### SUMMARY OF THE INVENTION

According to the present invention there is provided a method for single sign-on in a client-server system including a server and a client and an International Telecommunications Union (ITU) T.120 based remote presentation protocol, e.g. Microsoft Remote Desktop Protocol, communicates between the client node and the server. The client obtains a ticket for a user operating the client. The ticket identifies the security context of the user on the client. Upon connecting the client to the server, the ticket is transferred from the client to the server. The server authenticates the ticket with a security authority and when authenticated the server receives from the security authority a security context for the ticket. When the client so requests, applications are launched using that security context. Preferably, the server is a Microsoft Terminal Server. Preferably, the ticket transfer uses a channel within the remote presentation protocol, such as an RDP virtual channel. Preferably, the ticket transfer is performed by the client after connecting to the server using fixed credentials to an anonymous account. Preferably, the anonymous account is a restricted account with a security context different from the security context of the user. Preferably, a pool of active anonymous accounts is maintained on the server, to expedite the connection. Preferably, the ticket transfer by the client is to a Graphical Identification and Authentication (GINA) dynamic-link library (DLL) on the server.

According to the present invention there is provided a system for single sign-on in a client-server system including a Microsoft Terminal Server and a client and a remote presentation protocol based on ITU T.120 communicates between the client node and the Microsoft Terminal Server. A key-distribution center is attached to the Microsoft Terminal Server and the client. The client requests a ticket-granting ticket by providing the key-distribution center with identification and authentication information of a user of the client. The identification and authentication information is verified by the key-distribution center which sends the ticket-granting ticket to the client and the client stores the ticket-granting ticket. When the user requires a service firm the Microsoft Terminal Server, the client provides the key-distribution center with the ticket-granting ticket and with an identifier of the service. When the key-distribution center validates the ticket-granting ticket and recognizes the identifier, a service ticket is sent to the client. Upon receiving the service ticket, the service ticket is sent to the service, and the user is not required to manually log-in to the service. The service ticket is transferred by the Microsoft Terminal Server to the key-distribution center for identification and authentication. Preferably, upon authenticating the service ticket, the key-distribution center sends a security context of the user to the service; and the client is granted access to service. Preferably, the remote presentation protocol is Microsoft Remote Desktop Protocol.

According to the present invention there is provided a program storage device readable by a machine, tangibly embodying a program of instructions executable by the machine to perform a method as disclosed herein for single sign-on in a client-server system including a server and a client wherein a remote presentation protocol communicates between the client and the servers and the machine is the server and/or the client, and the server is a Microsoft Terminal Server and/or the remote presentation protocol is based on an ITU 1.120 protocol such as Microsoft Remote Desktop Protocol

### BRIEF DESCRIPTION OF THE DRAWINGS

The invention is herein described, by way of example only, with reference to the accompanying drawings, wherein:

FIG. 1 is a block diagram of the embodiment of the process of obtaining a security context ticket from a Kerberos KDC and using it to connect to a service;

FIG. 2 is a prior art diagram of a server-based computing system, where the a client nodes is authenticated by a server node over a network; and

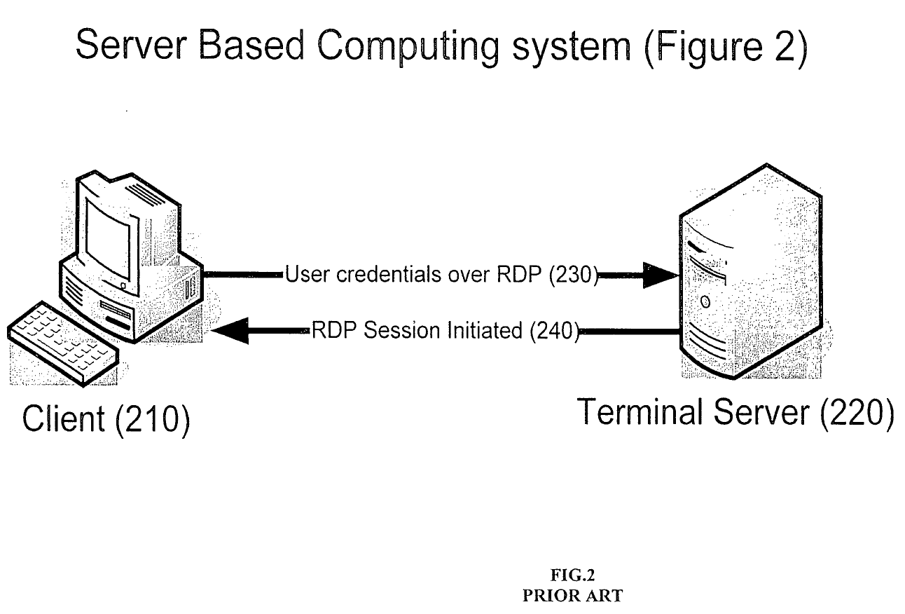

FIG. 3 is a block diagram of the process used to obtain a ticket of the user credentials, transfer the ticket to the server, and apply the ticket to launch an application on the server using the same security context.

### DESCRIPTION OF THE PREFERRED EMBODIMENTS

The present invention is of a system and method of performing single sign-on to a Microsoft Terminal Server so that a user need not reenter authentication information, such as username, password and domain. Instead a ticket representing credential information of the user on the client node is used to automatically sign on to the Terminal Server and launch applications on the Terminal Server in the same security context as that of the client node.

The principles and operation of a system and method of single sign-on, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

An embodiment of the present invention features a method for performing single sign-on from client software or device to Microsoft Terminal Servers. This embodiment is achieved by obtaining a ticket that represents the user's security context on the client, and transferring this ticket or a transferable ticket obtained from this ticket, to the server. On the server this ticket is used to instantiate applications or sessions with the same security context automatically, without requiring the user to sign on again. In order to perform the sign-on operation on the server, the server must be connected to a security authority that can authenticate the ticket provided by the client. Often that security authority will be the same key distribution center (KDC) that provides the ticket to the client.

In embodiments of the present invention features a method in which a user obtains a ticket that represents a security context on a client. There are various types of tickets, based on the security package used to authenticate the user's credentials. Examples of security packages include Kerberos and Windows NT LAN Manager challenge-response protocol (NTLM). The ticket is passed to a Terminal Server using the RDP correction, or another connection associated with that remote session. On the Terminal Server, the key is authenticated with a security authority and used to obtain the same security context as the client. Applications are then started in the session on the server within this security context. As a result, the user is signed on to the Terminal Server automatically, with the same identity as on the client.

In another embodiment of the present invention, anonymous sessions are previously defined on the Terminal Server. These sessions are not associated with any particular user. Instead these sessions ale available to any user, and so are restricted from performing any potentially harmful or dangerous operations. The user connects to such a session, for example using fixed authentication information, so the sign-on is performed without requiring the user to provide his or her actual credentials. Once connected to the anonymous session, a ticket that represents that particular user's credentials is transmitted to the server, and used to switch the session from the anonymous security context to that of the user. In another aspect of this embodiment of the present invention, the anonymous sessions are previously created and set to a pending state. As a result, connecting to such a session occurs without the delay of instantiating a new session, resulting in a speedup of the sign on process.

In another embodiment of the present invention, a Graphical Identification and Authentication (GINA) dynamic-link library is previously installed on the Terminal Server. Once the client operated by a user is connected to the Terminal Server, the GINA is launched by the Windows interactive login process. A ticket that represents the user's credentials is transmitted to the server, and used by the GRNA to identify and authenticate the user. The login process is then completed in the user's security context.

A method is described for installing components on the server and client that augment Microsoft Terminal Servers and RDP with single sign-on (SSO) functionality according to the present invention. Moreover, because RDP is a channel based communication protocol, it is possible to transfer the ticket to the server through the RDP connection itself.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

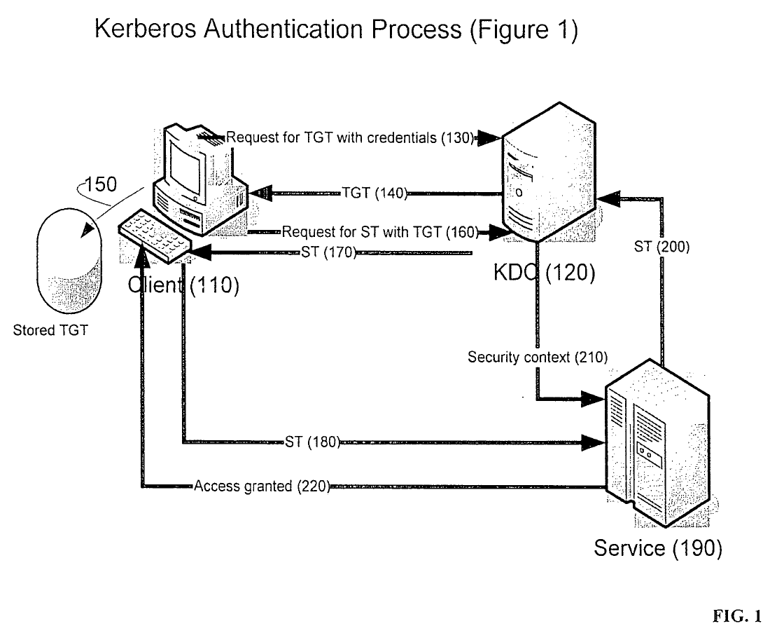

Referring now to the drawings, FIG. 1 illustrates a Kerberos SSO mechanism used to grant the user access to an authenticated resource without requiring the user to reenter authentication information:

1. The client (110) sends a request (step 130) to key distribution center (KCDC 120) for a Ticket Granting Ticket (TGT), providing username and password.

2. The KDC verifies, i.e. authenticates, the user's identity and, if verified, sends (step 140) the TGT back to the client.

3. The client stores (step 150) the TGT until access is required to a particular service.

4. At that time when a service is required, the TOT and service identifier are sent to the KDC (160).

5. If the TGT is valid and service identifier is known to the KDC, the KDC sends back (step 170) a Service Ticket.

6. The client sends (step 180) the Service Ticket to the service (190) automatically, instead of requiring the user to manually login to the service.

7. The service passes (step 200) the Service Ticket on to the KDC for identification and authentication.

8. If the Service Ticket is authenticated, the KDC sends (step 210) the security context of the user back to the service.

9. The service then grants (step 220) the client access using that security context.

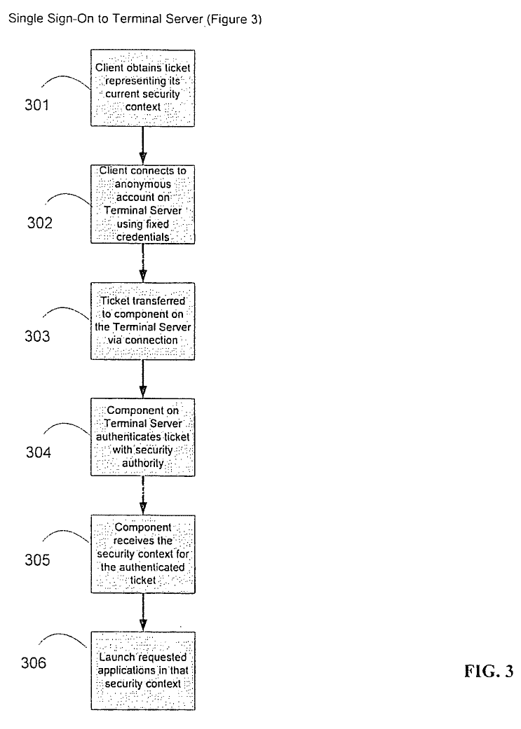

In another embodiment of the present invention, Microsoft Terminal Services and the Microsoft RDP protocol are augmented to support single-sign on using protocols such as Kerberos and NTLM. Referring now to FIG. 3, the following steps are performed:

301 Before establishing the connection to the server (190), client (110) obtains a ticket that represents the user's security context on the client.

302 When the connection is established, client (110) is connected to an anonymous, restricted account, which may not have the same security context as the user.

303 Once sign-on has succeeded, the ticket is transferred from client (110) to server (190) using a channel within the RDP connection, or some other connection between the client and the server.

304 Server (190) authenticates the ticket received from client (110) with the security authority.

305 If the authentication succeeds, server (190) receives the same security context as that of the user on client (110).

306 On server (190), the applications requested by client (110) are launched within that security context.

For some security protocols, such as NTLM, a handshake in the form of a token or packet exchange is required instead of a single token transfer. In such a case, authentication will be completed and the security context provided to the server only after the handshake has successfully completed.

In an aspect of this embodiment, a pool of sessions for the anonymous, restricted accounts is previously created on Terminal Server (I 90). The sessions in the pool are maintained on the Terminal Server (190) in a disconnected state. When a client that uses single sign-on connects to Terminal Server (190), a session from the pool is used for that connection, instead of creating a new session. As a result, the time required to establish a connection is reduced.

While the invention has been described with respect to a limited number of embodiments, it will be appreciated that many variations, modifications and other applications of the invention may be made.

What is claimed is:

1. In a client-server system, a method for single sign-on, the method comprising the steps of:
(a) providing a server and a client wherein a remote presentation protocol communicates between said client node and said server; wherein said remote presentation protocol is based on International Telecommunications Union (ITU) standard T.120;
(b) said client obtaining a ticket for a user operating said client, wherein said ticket represents a security context of said user on said client;
(c) upon connecting said client to said server, transferring said ticket from said client to said server;
(d) authenticating said ticket by said server with a security authority; and
(e) upon said authenticating, said server receiving from said security authority a security context for said ticket; and
(f) upon requesting by said client, launching applications using said security context.

2. The method, according to claim 1, wherein said server is a Microsoft Terminal Server.

3. The method, according to claim 1, wherein said remote presentation protocol is Microsoft Remote Desktop Protocol.

4. The method, according to claim 1, wherein said transferring of said ticket uses a virtual channel within said remote presentation protocol.

5. The method, according to claim 1, wherein said transferring of said ticket is performed by said client using an anonymous account having fixed credentials.

6. The method, according to claim 1, wherein said transferring a ticket is performed using an anonymous account on said server with a security context different from said security context of said user.

7. The method, according to claim 1, further comprising the step of:
(g) maintaining a pool of active anonymous sessions, whereby said connecting is expedited.

8. The method, according to claim 1, wherein said transferring of said ticket is performed by said client to a Graphical Identification and Authentication (GINA) dynamic-link library (DLL) on said server.

9. In a client-server system, a method for single sign-on, the method comprising the steps of:
(a) providing a Microsoft Terminal Server and a client wherein a remote presentation protocol communicates between said client and said Microsoft Terminal Server, wherein said remote presentation protocol is based on International Telecommunications Union (ITU) standard T.120;
(b) providing a key-distribution center operatively attached to said Microsoft Terminal Server and said client;
(c) requesting by said client for a ticket granting ticket by providing said key-distribution center with identification and authentication information of a user of said client;
(d) upon verifying said identification and authentication information by said key-distribution center, sending said ticket-granting ticket to said client;
(e) said client storing said ticket-granting ticket;
(f) upon said user requiring a service from said Microsoft Terminal Server, providing said key-distribution center with said ticket-granting ticket and with an identifier of said service;
(g) upon said key-distribution center validating said ticket-granting ticket and recognizing said identifier, sending a service ticket to said client;
(h) upon receiving said service ticket, sending by said client said service ticket to said service, whereby said user is not required to manually log-in to said service; and
(i) transferring said service ticket by said server to said key-distribution center for identification and authentication.

10. The method, according to claim 9, further comprising the steps of:
(j) upon authenticating said service ticket, sending by said key-distribution center a security context of said user to said service; and
(k) granting said client access to said service.

11. The method, according to claim 9, wherein said remote presentation protocol is Microsoft Remote Desktop Protocol.

12. A program storage device readable by a machine, tangibly embodying a program of instructions executable by the machine to perform a method for single sign-on in a client-server system including a Microsoft Terminal Server and a client wherein a remote presentation protocol communicates between said client and said Microsoft Terminal Server, wherein said remote presentation protocol is based on International Telecommunications Union (ITU) standard T.120; wherein said machine is selectably either the server or the client, the method according to claim 9.

13. A program storage device readable by a machine, tangibly embodying a program of instructions executable by the machine to perform a method for single sign-on in a client-server system including a server and a client wherein a remote presentation protocol based communicates between said client and said server, wherein said remote presentation protocol is based on International Telecommunications Union (ITU) standard T.120 wherein said machine is selectably either the server or the client, the method according to claim 1.
